(19) United States
(12) Patent Application Publication
(10) Pub. No.: US 2020/0222896 A1
(43) Pub. Date: Jul. 16, 2020

(54) ASSAY CUVETTE

(71) Applicant: SOCIETE DES PRODUITS NESTLE S.A., Vevey (CH)

(72) Inventors: DAVID BOOKER, San Diego, CA (US); Michael HALE, San Diego, CA (US); Bob EISELE, Vista, CA (US)

(73) Assignee: SOCIETE DES PRODUITS NESTLE SA, Vevey (CH)

(21) Appl. No.: 16/834,751

(22) Filed: Mar. 30, 2020

Related U.S. Application Data
(63) Continuation of application No. PCT/IB2019/051215, filed on Feb. 14, 2019.
(60) Provisional application No. 62/631,177, filed on Feb. 15, 2018.

(51) Int. Cl. B01L 3/00

(52) U.S. Cl. CPC B01L 3/502; B01L 3/523; B01L 2300/047; B01L 2300/0832; B01L 2200/16; B01L 2300/042

(57) ABSTRACT

Provided herein are assay cuvettes as well as related kits and methods for storing and transporting multiple solid reagents, and for performing diagnostic assays using the reagents held therein. The solid reagents are constrained within separate containers inside a lid of the cuvette. The containers are open to the inner chamber of the cuvette such that, when liquid buffer, reagent, or sample solutions is added to the cuvette, the solid reagents can be dissolved in the liquid to create within the cuvette a mixture that can then be assayed.

### CROSS-REFERENCES TO RELATED APPLICATIONS

This application is a continuation of PCT Application No. PCT/IB2019/051215, filed Feb. 14, 2019, which application claims the benefit of U.S. Provisional Patent Application No. 62/631,177, filed Feb. 15, 2018, which applications are incorporated by reference in their entireties for all purposes.

### BACKGROUND

Assay cuvettes are important tools in a variety of diagnostic assays used to detect target analytes within samples having relatively small volumes. The cuvettes typically hold an assay mixture that includes the sample to be tested, and reagents that are specific to the particular diagnostic assay being used. The reagents and sample often interact with one another to produce observable properties that are detected as part of the assay. It is difficult or impossible with many conventional assay cuvettes to maintain separation between these components of the assay mixture so that they do not interact with one another before the assay is to be carried out.

Some prior art cuvettes include one or more structural elements capable of partitioning one reagent from another for a period of time. These cuvettes, however, are not designed to separate two different solids from one another as well as from a liquid. Furthermore, the structures used to create the partitioning can also provide an undesired impediment to the eventual mixing or combining of the reagents at a later time. For example, some internal cuvette structures can cause increased challenges by preventing adequate internal liquid flow. This can in turn result in incomplete mixing, dead zones, liquid retention, or sample heterogeneity within the cuvette.

U.S. Pat. No. 4,522,923 describes an apparatus and method for conducting immunochemical reactions in a self-contained sealed unit that requires only the addition of an unknown sample and water. The apparatus comprises a test tube with at least three chambers each containing different chemicals, including a solid sphere, and separated from each other by a water-soluble barrier.

U.S. Pat. No. 5,362,654 describes a device comprising an absorbing nib, an external deformable container and an internal container having a frangible barrier, where the nib and internal container comprise reagents that are interactive with a sample for measuring an analyte.

U.S. Patent Application Publication No. US 2014/0370617 describes an apparatus for retaining solid state reagents and/or for processing a sample for a diagnostic test, where the apparatus avoids liquid “hang-up” that would otherwise result in loss of sample or fluid volume during sample transfer. The disclosure further describes diagnostic methods that employ the apparatus, so as to provide sensitive and accurate analyte detection.

Even in view of the foregoing, the need exists for assay cuvettes that can be used to store and transport multiple solid reagents such that the reagents are maintained separately from one another in a cuvette, yet can be readily combined in an assay mixture within the same cuvette. The presently disclosed devices and methods provide these and other needs.

### BRIEF SUMMARY

One provided cuvette comprises a hollow body enclosing an inner chamber having an open chamber top. The cuvette further comprises a lower lid having an inner wall, an outer wall, an open lid top, and an open lid bottom. At least a portion of the lower lid is configured to fit inside the inner chamber proximate to the open chamber top. The lower lid comprises one or more (e.g., two or more) containers connected to the inner wall, wherein each of the containers has an open container top. In certain aspects, the lower lid comprises two or more such containers. The lower lid further comprises a securing means connected to the hollow body. The cuvette further comprises an upper lid wherein at least a portion of the upper lid is configured to fit inside the lower lid proximate to the open lid top.

In some embodiments, an outer liquid tight seal is formed between the lower lid outer wall and the hollow body upon insertion of the lower lid into the hollow body. In some embodiments, an inner liquid tight seal is formed between the upper lid and the lower lid inner wall upon insertion of the upper lid into the lower lid. In some embodiments, the securing means comprises a hinge. In some embodiments, the securing means comprises a tether.

In some embodiments, the one or more (e.g., two or more) containers are disposed along a strap that connected to the inner wall. In some embodiments, the strap is connected to the inner wall at no more than two locations. In some embodiments, the one or more (e.g., two or more) containers each independently comprise a thermoplastic elastomer.

In some embodiments, the hollow body further comprises an optical window having an inner window surface and an outer window surface. In some embodiments, the inner surface and the outer surface are substantially parallel to one another. In some embodiments, the inner surface and the outer surface each independently have a draft angle with a magnitude less than 5 degrees. In some embodiments, the optical window is transparent to visible light. In some embodiments, the optical window is transparent to ultraviolet light.

In some embodiments, the hollow body further comprises an upper surface extending outward from the open chamber top, the lower lid further comprises a flange extending outward from the outer wall of the lid, and the cuvette further comprises a spacer positioned between and in contact with the upper surface and the flange when the lower lid is inserted into the inner chamber. In some embodiments, the spacer comprises a tab extending outward from the hollow body. In some embodiments, the lower lid comprises a thermoplastic elastomer.

In some embodiments, the hollow body comprises two or more supports (e.g., feet) configured to support the cuvette in an upright standing position. In some embodiments, the cuvette further comprises a horizontal air gap between each of the two or more feet and the inner chamber. In some embodiments, a portion of the hollow body comprises a substantially cylindrical outer surface, and a portion of the hollow body comprises a substantially planar and rectangular outer surface. In some embodiments, the substantially planar and rectangular outer surface comprises printed indicia. In some embodiments, the printed indicia comprises a barcode. In some embodiments, each of the one or more (e.g., two or more) containers has an open container bottom.

In some embodiments, the cuvette further comprises a first solid composition comprising a first reagent, wherein the first solid composition is within one of the one or more (e.g., two or more) containers. In some embodiments, the first solid composition is a bead or a pellet. In some embodiments, the bead or pellet comprises lyophilized form of the reagent. In some embodiments, the bead or pellet comprises a solid support that is coated with the first reagent. In some embodiments, the bead or pellet comprises a solid support that encapsulates the first reagent. In some embodiments, the first reagent comprises a chromophore, a fluorophore, or a quencher. In some embodiments, the first reagent comprises a cryptate dye.

In some embodiments, the cuvette further comprises a second solid composition comprising a second reagent, wherein the first and second solid compositions are each independently within a separate container of the two or more containers. In some embodiments, the first solid composition comprises a donor molecule and the second solid composition comprises an acceptor molecule. In some embodiments, the donor molecule comprises a cryptate dye and the acceptor molecule comprises a chromophore, a fluorophore, or a quencher. In some embodiments, the first solid composition comprises a primer and the second solid composition comprises a probe.

Also provided are kits for performing a diagnostic assay, wherein the kit comprises a cuvette in accordance with any of the provided embodiments. The kit further comprises a buffer suitable for dissolving the first reagent, wherein the buffer is compatible with the diagnostic assay. In some embodiments, the first reagent comprises a chromophore, a fluorophore, or a quencher.

Also provided are methods for detecting an analyte in a sample, wherein the method comprises providing a cuvette. The cuvette comprises a hollow body enclosing an inner chamber having an open chamber top. The cuvette further comprises a lower lid having an inner wall, an outer wall, an open lid tip, and an open lid bottom. At least a portion of the lower lid is fitted inside the inner chamber proximate to the open chamber top. The lower lid comprises one or more (e.g., two or more) containers connected to the inner wall. Each of the containers has an open container top. The lower lid further comprises a hinge connected to the hollow body. The cuvette further comprises an upper lid, wherein at least a portion of the upper lid is fitted inside the lower lid proximate to the open lid top. The cuvette further comprises a solid composition comprising a reagent, wherein the solid reagent is within one of the one or more (e.g., two or more) containers. The method further comprises providing a buffer suitable for dissolving the reagent. The method further comprises removing the lower lid from within the inner chamber. The method further comprises dispensing the buffer into the inner chamber. The method further comprises adding the sample to the inner chamber. The method further comprises inserting at least a portion of the lower lid inside the inner chamber proximate to the open chamber top. The method further comprises mixing the cuvette such that the solid composition, the buffer, and the sample are combined, therefore forming an assay mixture. The method further comprises detecting the analyte in the assay mixture.

In some embodiments, the detecting of the analyte in the assay mixture comprises exciting the assay mixture with light and analyzing fluorescence emissions from the assay mixture. In some embodiments, the cuvette further comprises a spacer, and the method further comprises detaching the spacer from the cuvette subsequent to removing the lower lid from within the inner chamber and prior to inserting at least a portion of the lower lid inside the inner chamber. In some embodiments, an outer liquid tight seal is formed between the lower lid outer wall and the hollow body. In some embodiments, an inner liquid tight seal is formed between the upper lid and the lower lid inner wall. In some embodiments, the securing means comprises a hinge. In some embodiments, the securing means comprises a tether. In some embodiments, the reagent comprises a chromophore, a fluorophore, or a quencher. In some embodiments, the reagent comprises a cryptate dye. In some embodiments, the sample is derived from an animal. In some embodiments, the sample is derived from a human. In some embodiments, the sample comprises blood or urine.

Also provided are devices for holding reagents. The devices comprise a lower lid having an inner wall, an outer wall, an open lid top, and an open lid bottom. The lower lid further comprises one or more (e.g., two or more) containers for holding reagents, wherein each of the containers is connected to the inner wall, and wherein each of the containers has an open container top. The device further comprises an upper lid, wherein at least a portion of the upper lid is configured to fit inside the lower lid proximate to the open lid top.

In some embodiments, an inner liquid tight seal is formed between the upper lid and the lower lid inner wall upon insertion of the upper lid into the lower lid. In some embodiments, the lower lid further comprises a securing means to connect to a hollow body. In some embodiments, the securing means comprises a hinge. In some embodiments, the securing means comprises a tether. In some embodiments, each of the one or more (e.g., two or more) containers has an open container bottom.

In some embodiments, the device further comprises a first solid composition comprising a first reagent, wherein the first solid composition is within one of the one or more (e.g., two or more) containers. In some embodiments, the first solid composition is a bead or a pellet. In some embodiments, the bead or pellet comprises a lyophilized form of the first reagent. In some embodiments, the bead or pellet comprises a solid support that is coated with the first reagent.

These and other embodiments will become more apparent when read with the detailed description and figures which follow.

### BRIEF DESCRIPTION OF THE DRAWINGS

FIG. 1A is an illustration of a cuvette in an open configuration in accordance with an embodiment.

FIG. 1B is an illustration of the cuvette of FIG. 1A in a closed configuration.

FIG. 2 is a cross-section of the hollow body of the cuvette of FIG. 1A.

FIG. 3A is an illustration of the lower lid of the cuvette of FIG. 1A.

FIG. 3B is an illustration of the lower lid of FIG. 3A having beads within its containers.

FIG. 4 is an illustration of the cuvette of FIGS. 1A and 1B having a spacer positioned between the hollow body and the lower lid.

FIG. 5 is an illustration of the upper lid of the cuvette of FIG. 1A.

FIG. 6 is a flowchart of a process in accordance with an embodiment.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

Unless defined otherwise, all terms of art, notations and other scientific terms or terminology used herein have the same meaning as is commonly understood by one of ordinary skill in the art to which this disclosure belongs. As appropriate, procedures involving the use of commercially available kits and reagents are generally carried out in accordance with manufacturer defined protocols and/or parameters unless otherwise noted.

The present disclosure generally relates to cuvettes that can be used with diagnostic instruments and assays. These cuvettes are designed to provide advantageous capabilities, such as allowing them to hold assay reagents separately from one another until such time as when an assay mixture is desired to be formed. For example, it can be beneficial for solid reagents to be prevented from prematurely contacting or interacting with one another, or with any other liquid reagents that may also be present. This can be the case, for example, when components of one or more of the reagents degrade, transform, or are consumed when in the presence of conditions or compounds associated with another of the reagents. It has been difficult to achieve such reagent separation with existing cuvettes as discussed above.

Most conventional cuvettes include a single container in the form of an internal cavity. An assay mixture or sample is typically added to this cavity prior to having one or more properties of the mixture or sample measured or detected by an analytical instrument. With such conventional cuvettes, either the assay mixture or sample is prepared external to the cuvette and added to the cuvette thereafter, or a mixture is prepared within the cuvette as different mixture components are introduced into the cuvette. In either case, there is no structure or means for separately storing multiple reagents within the cuvette, and then combining these reagents within the cuvette only immediately prior to an assay or measurement.

The inventors have now discovered that specific cuvette designs permit the storage and transport of multiple solid and/or liquid reagents within a single device, such that the reagents are only combined with one another when desired by a user. In particular embodiments, the disclosed cuvettes include two or more containers configured to separately hold two or more solid reagents. These containers can be bound together by a single strap, or any suitable connector, that connects them to the interior of a removably attachable cuvette lid, such that by removing the lid, liquid can be added to the cuvette interior while the solid reagents are kept separate within the attached lid. With the lid reinserted into the cuvette, simple mixing by, for example, inversion, can be used to combine the liquid and solid reagents. Because the solid reagent containers can be connected to the lid with only a single thin strap, advantageously liquid within the cuvette can easily and freely flow around this strap into the lid space, to contact and mix with any solids held therein.

In certain aspects, the cuvette is shaped and configured to be inserted into an external device or analyzer in a particular orientation, similar to a lock and key. In one embodiment, the cuvette has a rectangular side and three cylindrical sides. This configuration can allow for insertion of the cuvette into an external device in a single configuration so as to prevent improper insertion of the cuvette into the device.

### I. Assay Cuvettes

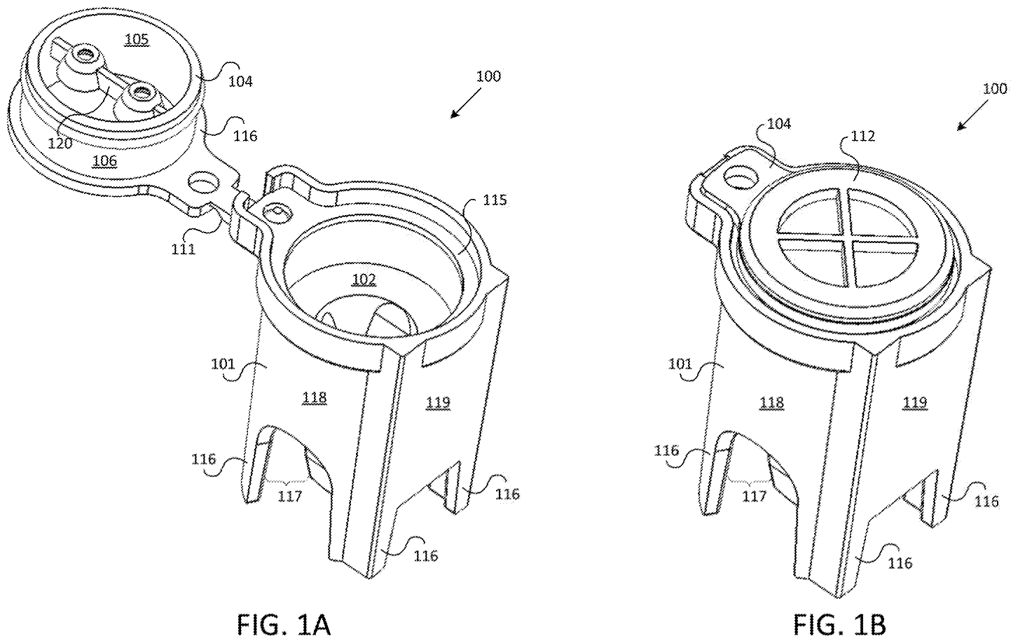

FIGS. 1A and 1B illustrate a cuvette for separately holding solid and/or liquid reagents for performing a diagnostic assay in accordance with an embodiment. The view in FIG. 1A is of the cuvette in an open configuration, and the view in FIG. 1B is of the same cuvette in a closed configuration. Shown in the figures is a cuvette (100) that includes a hollow body (101), a lower lid (104), and an upper lid (112). The hollow body (101) encloses an inner chamber (102) that is open at the top at an open chamber top (103). The open chamber top (103) is bordered by an upper surface (115) extending outward from the open chamber top (103). A portion of the hollow body (101) includes a substantially cylindrical outer surface (118), and another portion of the hollow body (101) includes a substantially rectangular outer surface (119).

In the illustrated embodiment, the lower lid (104) is connected to the hollow body (101) via a hinge (111), such that the lower lid (104) remains attached to the hollow body (101) when the cuvette is in both an open (FIG. 1A) and a closed (FIG. 1B) configuration. The lower lid (104) has an inner wall (105) and an outer wall (106) and is open at its top and bottom at an open lid top (107) and an open lid bottom (108), respectively. The lower lid (104) is configured such that when the cuvette (100) is closed, at least a portion of the lower lid (104) fits inside the inner chamber (102) proximate to the open chamber top (103), forming a liquid tight seal between the outer wall (106) and the hollow body (101). As used herein, the term “liquid tight seal” refers to a seal between two or more structural elements of a device, wherein the seal limits liquid passage under typical operating pressures of the device. A flange (116) extends outward from the outer wall (106), such that when the lower lid (104) is inserted into the inner chamber (102) of the hollow body (101), the flange (116) rests adjacent to the upper surface (115) of the hollow body (101). The lower lid also includes two containers (109) that are connected (such as mechanically or by molding) to the inner wall (105). Each of the containers (109) is open at its top at an open container top (110).

Further, in the illustrated embodiment, the upper lid (112) is configured such that when the cuvette (100) is closed, at least a portion of the upper lid (112) fits inside the lower lid (104) proximate to the open lid top (107), forming a liquid tight seal between the upper lid (112) and the inner wall (105) of the lower lid (104). In this way, when the cuvette (100) is closed as shown in FIG. 1B, the inner chamber (102) is bounded at, or in other words disposed between, the sides and bottom by the hollow body (101), and at the top by the upper lid (112).

A. Hollow Body

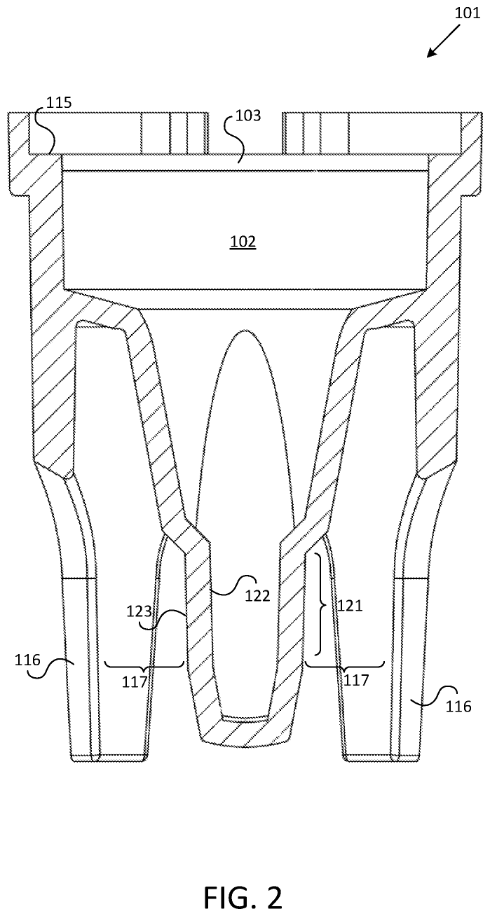

FIG. 2 provides a cross-sectional side view of the hollow body (101) of the cuvette (100) of FIGS. 1A and 1B. Shown in FIG. 2 is the inner chamber (102) having an open chamber top (103). In some embodiments, and as is shown in FIG. 2, the inner chamber can have a cross-sectional area that reduces from the open chamber top (102) to the inner chamber bottom. In the embodiment shown, the inner chamber (102) has a wider cross-sectional area proximate to the open chamber top (102), so as to accommodate the insertion of the lower lid (104). In the embodiment shown, the inner chamber (102) has a narrower cross-sectional area in a lower portion configured to hold an assay mixture to be analyzed. This narrower lower portion can be bounded by structures of the hollow body (101) acting as optical windows (121), through which an assay mixture can be interrogated for target detection. The optical windows (121) each have an inner window surface (122) and an outer window surface (123).

In some embodiments, and as is shown in FIGS. 1A, 1B, and 2, the hollow body (101) includes four feet (116) or other support features configured to support the cuvette (100) in an upright standing position. Alternatively, the hollow body (101) can include two, three, five, six, seven, eight, nine, ten, or more than ten feet (116). A horizontal air gap (117) can separate each of the feet from the inner chamber (102). The feet (116) can also be separated from one another by an arch or other gap along the perimeter of the hollow body. In this way, one or more of the optical windows (121) can be positioned in the optical paths of one or more light beams that pass between, and not through, the feet (116).

In some embodiments, and as is shown in FIG. 2, the hollow body (101) can also include an upper surface (115) extending outward from the open chamber top (103). Also as shown in FIG. 2, the upper surface can be recessed within the outer walls of the hollow body (101), forming a recessed rim around the upper perimeter of the inner chamber (102).

The hollow body can, for example, have an outer diameter proximate to the open chamber top ranging from 0.7 inches to 1.5 inches, e.g., from 0.7 inches to 1.18 inches, from 0.78 inches to 1.26 inches, from 0.86 inches to 1.34 inches, from 0.94 inches to 1.42 inches, or from 1.02 inches to 1.5 inches. In terms of upper limits, the hollow body outer diameter can be less than 1.5 inches, e.g., less than 1.42 inches, less than 1.34 inches, less than 1.26 inches, less than 1.18 inches, less than 1.1 inches, less than 1.02 inches, less than 0.94 inches, less than 0.86 inches, or less than 0.78 inches. In terms of lower limits, the hollow body outer diameter can be greater than 0.7 inches, e.g., greater than 0.78 inches, greater than 0.86 inches, greater than 0.94 inches, greater than 1.02 inches, greater than 1.1 inches, greater than 1.18 inches, greater than 1.26 inches, greater than 1.34 inches, or greater than 1.42 inches.

The ratio of the hollow body inner diameter proximate to the open chamber top, to the hollow body outer diameter proximate to the open chamber top, can, for example, range from 40% to 90%, e.g., from 40% to 70%, from 45% to 75%, from 50% to 80%, from 55% to 85%, or from 60% to 90%. In terms of upper limits, the ratio of the inner diameter to the outer diameter can be less than 90%, e.g., less than 85%, less than 80%, less than 75%, less than 70%, less than 65%, less than 60%, less than 55%, less than 50%, or less than 45%. In terms of lower limits, the ratio of the inner diameter to the outer diameter can be greater than 40%, e.g., greater than 45%, greater than 50%, greater than 55%, greater than 60%, greater than 65%, greater than 70%, greater than 75%, greater than 80%, or greater than 85%.

The hollow body can, for example, have a height ranging from 1 inch to 2 inches, e.g., from 1 inch to 1.6 inches, from 1.1 inches to 1.7 inches, from 1.2 inches to 1.8 inches, from 1.3 inches to 1.9 inches, or from 1.4 inches to 2 inches. In terms of upper limits, the hollow body can have a height that is less than 2 inches, e.g., less than 1.9 inches, less than 1.8 inches, less than 1.7 inches, less than 1.6 inches, less than 1.5 inches, less than 1.4 inches, less than 1.3 inches, less than 1.2 inches, or less than 1.1 inches. In terms of lower limits, the hollow body can have a height that is greater than 1 inch, e.g., greater than 1.1 inches, greater than 1.2 inches, greater than 1.3 inches, greater than 1.4 inches, greater than 1.5 inches, greater than 1.6 inches, greater than 1.7 inches, greater than 1.8 inches, or greater than 1.9 inches.

The materials used to construct the hollow body can be selected for properties that include low density, high transparency, low birefringence, low water absorption, high rigidity, and good compatibility with blood, urine, plasma, feces, or other biological samples. In some embodiments, the hollow body is molded from materials that include one or more cyclic olefin copolymers. In some embodiments, the hollow body materials consist of one or more or more cyclic olefin copolymers. Suitable commercially available cyclic olefin copolymers include, for example, TOPAS® 8007X10 available from Topas Advanced Polymers (Frankfurt, Germany).

In some embodiments, the lower portion of the inner chamber of the hollow body has a smaller diameter or width than that of the upper portion of the inner chamber. In some embodiments, the upper portion of the inner chamber has the general shape of a relatively larger cylindrical cavity, and the lower portion of the inner chamber has the general shape of a relatively smaller rectangular cavity. The walls of the inner chamber proximate to this lower portion can be configured as optical windows, such that one or more beams of light can be transmitted through one or more faces of the rectangular cavity. In general, the optical windows comprise material selected for optical transparency at desired wavelengths. The optical windows can, for example, be transparent to visible light, ultraviolet light, or both.

The inner chamber of the hollow body proximate to the optical window can, for example, have a width ranging from 0.1 inches to 0.2 inches, e.g., from 0.1 inches to 0.16 inches, from 0.11 inches to 0.17 inches, from 0.12 inches to 0.18 inches, from 0.13 inches to 0.19 inches, or from 0.14 inches to 0.2 inches. In terms of upper limits, the inner chamber can have a width proximate to the optical window that is less than 0.2 inches, e.g., less than 0.19 inches, less than 0.18 inches, less than 0.17 inches, less than 0.16 inches, less than 0.15 inches, less than 0.14 inches, less than 0.13 inches, less than 0.12 inches, or less than 0.11 inches. In terms of lower limits, the inner chamber can have a width proximate to the optical window that is greater than 0.1 inches, e.g., greater than 0.11 inches, greater than 0.12 inches, greater than 0.13 inches, greater than 0.14 inches, greater than 0.15 inches, greater than 0.16 inches, greater than 0.17 inches, greater than 0.18 inches, or greater than 0.19 inches.

In some embodiments, the inner window surface and the outer window surface of each optical window are substantially planar and substantially parallel to one another. As used herein, the term “substantially parallel” refers to a relationship between two surfaces such that dihedral angle formed by the two planes that best approximate the two surfaces is less than 5 degrees, e.g., less than 4 degrees, less than 3 degrees, less than 2 degrees, less than 1 degree, less than 0.9 degrees, less than 0.8 degrees, less than 0.7 degrees, less than 0.6 degrees, less than 0.5 degrees, less than 0.4 degrees, less than 0.3 degrees, less than 0.2 degrees, or less than 0.1 degrees. The use of inner window surfaces and outer window surfaces that are substantially parallel to one another can help minimize optical distortion of light transmitted through the optical window.

Optical distortions of the optical window can also be minimized by reducing the draft angle of the inner and outer window surfaces. As used herein, the term “draft angle” refers to a measure of the amount of tapering of a surface. The draft angle of the inner window surface and the outer window surface can each independently be, for example, less than 5 degrees, e.g., less than 4 degrees, less than 3 degrees, less than 2 degrees, less than 1 degree, less than 0.9 degrees, less than 0.8 degrees, less than 0.7 degrees, less than 0.6 degrees, less than 0.5 degrees, less than 0.4 degrees, less than 0.3 degrees, less than 0.2 degrees, or less than 0.1 degrees.

In some embodiments, at least a portion of the outer surface of the hollow body has a substantially cylindrical shape. In some embodiments, a majority of the outer surface of the hollow body has a substantially cylindrical shape. In some embodiments, at least a portion of the outer surface of the hollow body has a substantially rectangular shape. Indicia can be printed onto the portion of the outer surface having a substantially rectangular shape. The printed indicia can include one or more alphanumeric characters. The printed indicia can include one or more shapes or logos. The printed indicia can include one or more one-dimensional or two-dimensional barcodes. The barcodes can be used to identify one or more reagents or samples loaded within or otherwise supplied with a particular cuvette.

B. Lower Lid

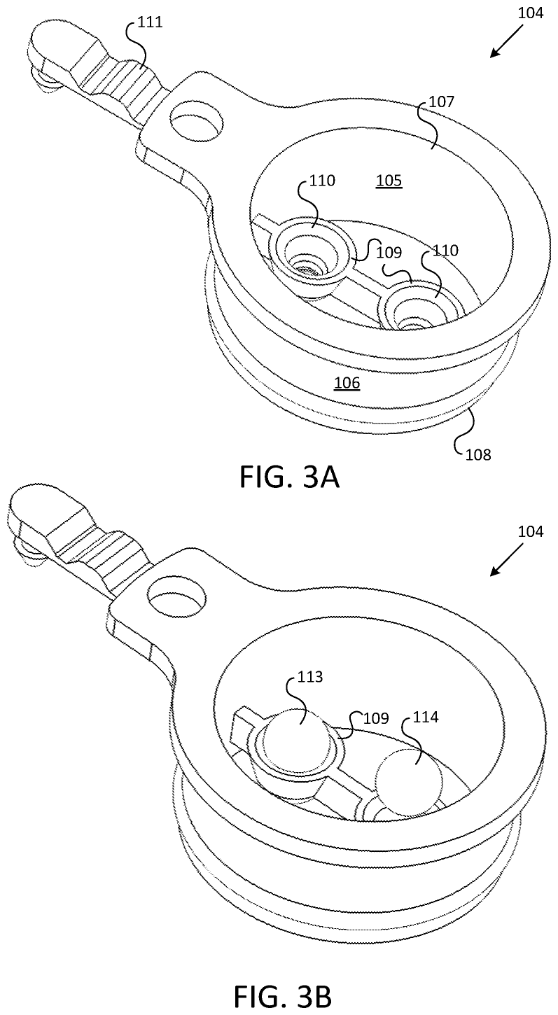

FIGS. 3A and 3B illustrate the lower lid (104) of the cuvette (100) of FIGS. 1A and 1B. Shown in the figures are the outer wall (106), the inner wall (105), the open lid top (107), and the open lid bottom (108) of the lower lid (104). In some embodiments, and as shown in FIGS. 1A, 3A, and 3B, the configurations of the inner and outer walls and the open lid top and bottom together give the lower lid a generally annular shape. Also shown in FIGS. 1A, 3A and 3B are two containers (109), each having an open container top (110). In some embodiments, and as shown in FIGS. 1A, 3A, and 3B, the containers of the lower lid (104) are disposed along a strap that is connected to the inner wall (105) of the lower lid (104) at two locations. One end of the lower lid (104) is connected to a hinge (111), that in turn connects to the hollow body (101), thereby attaching the lower lid (104) to the hollow body (101). The view in FIG. 3A is of the lower lid (104) with its containers (109) unoccupied, and the view in FIG. 3B is of the lower lid (104) with two generally spherical beads or pellets inserted into the containers (109). A first bead (113) is shown inserted into one of the two containers (109), and a second bead (114) is shown in the process of inserting into the other of the two containers (109).

Although two containers are shown in FIGS. 1A, 3A, and 3B, one or more containers are contemplated. The number of containers within the lower lid can, for example, be two, three, four, five, six, seven, eight, nine, ten, or more than ten. The two or more containers can be identical in shape, or can be different in shape. The two or more containers can be identical in size, or can be different in size. In some embodiments, two or more of the containers are identical in shape and/or size, and one or more containers are different in shape and/or size from the two or more identical containers. A skilled artisan will recognize that the containers can be any geometrical shape and are not limited to number or geometry. A spherical container is shown, but the geometry is non-limiting.

In some embodiments, each of the two or more containers are frustoconical in shape. The frustoconical containers can be open at the top and/or bottom, with closed sides. In this way, the solid sides can hold a solid within each container, and the open top and/or bottom of each container can permit fluid to contact the held solid. The frustoconical containers can each independently have a cone angle ranging, for example, from 20 degrees to 50 degrees, e.g., from 20 degrees to 38 degrees, from 23 degrees to 41 degrees, from 26 degrees to 44 degrees, from 29 degrees to 47 degrees, or from 32 degrees to 50 degrees. In terms of upper limits, each frustoconical container can independently have a cone angle less than 50 degrees, e.g., less than 47 degrees, less than 44 degrees, less than 41 degrees, less than 38 degrees, less than 35 degrees, less than 32 degrees, less than 29 degrees, less than 26 degrees, or less than 23 degrees. In terms of lower limits, each frustoconical container can independently have a cone angle greater than 20 degrees, e.g., greater than 23 degrees, greater than 26 degrees, greater than 29 degrees, greater than 32 degrees, greater than 35 degrees, greater than 38 degrees, greater than 41 degrees, greater than 44 degrees, or greater than 47 degrees.

The lower lid can, for example, have a height ranging from 0.25 inches to 0.55 inches, e.g., from 0.25 inches to 0.43 inches, from 0.28 inches to 0.46 inches, from 0.31 inches to 0.49 inches, from 0.34 inches to 0.52 inches, or from 0.37 inches to 0.55 inches. In terms of upper limits, the lower lid can have a height that is less than 0.55 inches, e.g., less than 0.52 inches, less than 0.49 inches, less than 0.46 inches, less than 0.43 inches, less than 0.4 inches, less than 0.37 inches, less than 0.34 inches, less than 0.31 inches, or less than 0.28 inches. In terms of lower limits, the lower lid can have a height that is greater than 0.25 inches, e.g., greater than 0.28 inches, greater than 0.31 inches, greater than 0.34 inches, greater than 0.37 inches, greater than 0.4 inches, greater than 0.43 inches, greater than 0.46 inches, greater than 0.49 inches, or greater than 0.52 inches.

In some embodiments, when the upper lid is inserted into the lower lid, the clearance between the open container tops and the upper lid is less than the nominal diameter of solid reagent beads held within the containers. This small clearance can assist in constraining the beads during storage and transport, and can mitigate opportunities for damage occurring to the beads prior to their use in a diagnostic assay. Typically, solid reagent beads when not properly constrained can be prone to crushing, grinding, or other abrasion.

In some embodiments, and as shown in FIGS. 1A, 3A, and 3B, the strap is connected to the inner wall of the lower lid at only two locations. Alternatively, the strap can be connected to the inner wall at one, three, four, five, six, seven, eight, nine, ten, or more than ten locations. In general, by connecting the strap, and therefore the containers, to the wall at more locations, stability and rigidity is gained. Increasing the number of connections can also introduce more impediments to fluid flow within the lower lid, however. This can produce an obstacle to adequate mixing of different assay reagents. By connecting the strap to the lower lid at two locations, a balance between stability and fluid flow can be achieved.

In some embodiments, the lower lid is connected to the hollow body of the cuvette by a tether instead of by a hinge. The tether can be relatively long, i.e., longer than the diameter of the lower lid, and can comprise a flexible material. The tether, hinge, or other securing means can be used to connect the lower lid to the hollow body such that any beads held within the lower lid are thereby associated with the hollow body. This can be useful, for example, in enabling assay custody by allowing a printed barcode or other identification mark on the hollow body to also refer to the contents of beads contained within a particular lower lid that is connected to the particular hollow body.

In some embodiments, and as shown in FIGS. 1A, 3A, and 3B, the lower lid includes a flange disposed on the upper portion of the outer wall, and extending outward from the outer wall. When the lower lid is inserted into the inner chamber of the hollow body, the flange can position the lower lid within a recessed rim at the upper portion of the hollow body, with the flange resting against the upper surface bordering the open chamber top of the inner chamber.

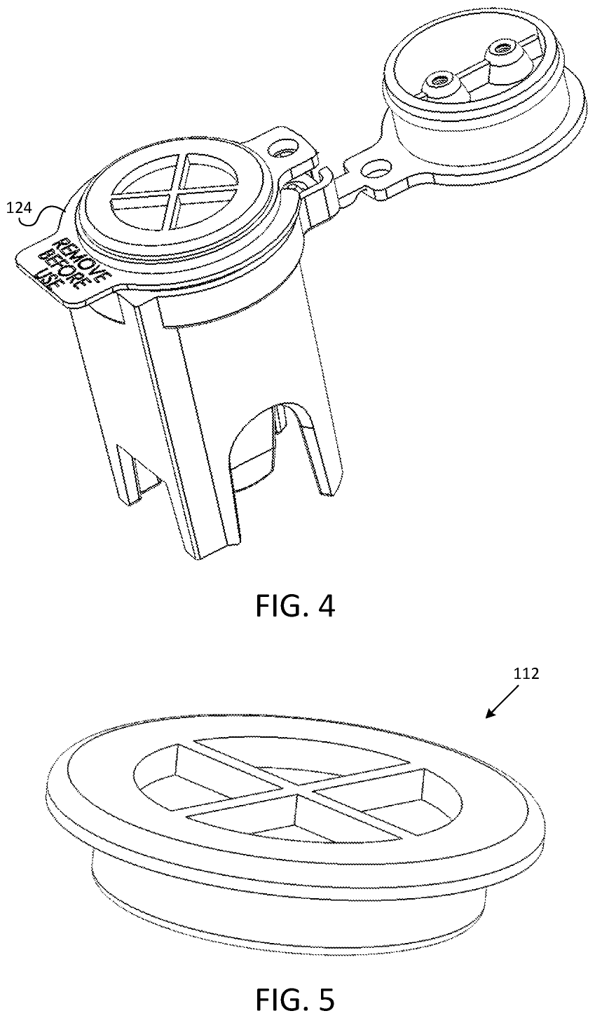

FIG. 4 illustrates an embodiment in which the cuvette includes a spacer (124) that is configured to sit between and adjacent to the lower lid flange and the hollow body upper surface as the lower lid is inserted into the inner chamber. The spacer then acts to prevent the lower lid from being inserted into the inner chamber as far as it otherwise could. In some embodiments, when the lower lid flange is positioned against the hollow body upper surface, the lower lid is recessed into the inner chamber far enough that it is difficult for a user to remove the inserted lower lid. In some aspects, this difficulty is an intentional feature of the design and is intended to minimize the ability of tampering with the cuvette contents once all components of an assay mixture have been added. The spacer can be present before these assay mixture components have been added, preventing the lower lid from fully inserting into the inner chamber, and allowing a user to removably insert the lower lid. In some embodiments, the spacer includes an outwardly extending tab that can be gripped by a user to assist in removing the spacer and lower lid from within the hollow body. As all assay mixture components are being added to the cuvette, the spacer can be removed, and the lower lid and associated upper lid can be fully inserted into the inner chamber to seal the cuvette. In some embodiments, the spacer initially encircles the lower lid, and removal of the spacer involves tearing or cutting the spacer so that it no longer fully encircles the lower lid. The spacer can, for example, comprise a paper, cardboard, or plastic material that can easily be torn or cut.

The materials used to construct the inner and outer walls of the lower lid can be selected for properties that include a greater flexibility than that of the hollow body. A more flexible material can allow for the lower lid to compress slightly when inserted into the inner chamber of the hollow body, better enabling the formation of a liquid tight seal. In some embodiments, the lower lid comprises one or more thermoplastic elastomers.

The materials used to construct the containers of the lower lid can be selected for properties that include a greater flexibility than that of the hollow body. A more flexible material can allow for the containers to compress slightly when a solid bead is inserted therein, better enabling the containers to constrain the beads, and reducing the likelihood that the container will abrade the held bead. In some embodiments, each of the two or more containers comprises one or more thermoplastic elastomers. In some embodiments, the materials of the lower lid are selected to have a lower durometer than those of the hollow body and the upped lid.

C. Upper Lid

FIG. 5 illustrates the upper lid (112) of the cuvette (100) of FIGS. 1A and 1B. Although a cross-hatch design is shown, any suitable geometry can be used. The upper lid can have a height ranging from, for example, 0.1 inches to 0.2 inches, e.g., from 0.1 inches to 0.16 inches, from 0.11 inches to 0.17 inches, from 0.12 inches to 0.18 inches, from 0.13 inches to 0.19 inches, or from 0.14 inches to 0.2 inches. In terms of upper limits, the upper lid can have a height that is less than 0.2 inches, e.g., less than 0.19 inches, less than 0.18 inches, less than 0.17 inches, less than 0.16 inches, less than 0.15 inches, less than 0.14 inches, less than 0.13 inches, less than 0.12 inches, or less than 0.11 inches. In terms of lower limits, the upper lid can have a height that is greater than 0.1 inches, e.g., greater than 0.11 inches, greater than 0.12 inches, greater than 0.13 inches, greater than 0.14 inches, greater than 0.15 inches, greater than 0.16 inches, greater than 0.17 inches, greater than 0.18 inches, or greater than 0.19 inches.

The materials used to construct the upper lid can be selected for properties that include a greater flexibility than that of the hollow body and/or the inner wall of the lower lid. A more flexible material can allow for the upper lid to compress slightly when inserted into the lower lid, better enabling the formation of a liquid tight seal. In some embodiments, the upper lid comprises molded polymers such as one or more thermoplastic elastomers. In some embodiments, the materials of the upper lid are selected to have a higher durometer than those of the lower lid. In some embodiment, the upper lid comprises polypropylene.

In some embodiments, the upper lid comprises one or more prongs extending downward from the bottom portion of the upper lid. These prongs can act to prevent the upper lid from being inserted too far into the lower lid, thereby crushing or otherwise damaging any beads held therein.

D. Solid Reagent Compositions

In some embodiments, and as shown in FIG. 3B, the lower lid (104) includes a first solid composition (113) within one of the containers (109). The first solid composition can be in the form of a bead or pellet. The first solid composition can have a generally spherical shape. Typically the first solid composition includes a first reagent of a diagnostic assay to be performed using the cuvette. The first solid composition can also include more than one reagent of the diagnostic assay. In some embodiments, the first solid composition is a bead or pellet formed by lyophilization of a solution that includes the first reagent. In some embodiments, the first solid composition includes a solid support that is coated with the first reagent. In some embodiments, the first solid composition includes a solid support that encapsulates the first reagent. In some embodiments, the first solid composition includes a dispersion of the first reagent within a solid support. The first solid composition can include additional components such as one or more binding agents, salts, or buffers.

In some embodiments, and as shown in FIG. 3B, the lower lid (104) also includes a second solid composition (114) within another of the containers (109). The second solid composition can also be in the form of a bead or pellet. The second solid composition can also have a generally spherical shape. Typically the second solid composition includes a second reagent of the diagnostic assay to be performed using the cuvette. The second solid composition can also include more than one reagent of the diagnostic assay. In some embodiments, the second solid composition is a bead or pellet formed by lyophilization of a solution that includes the second reagent. In some embodiments, the second solid composition includes a solid support that is coated with the second reagent. In some embodiments, the second solid composition includes a solid support that encapsulates the second reagent. In some embodiments, the second solid composition includes a dispersion of the second reagent within a solid support. The second solid composition can include additional components such as one or more binding agents, salts, or buffers.

The first and second reagents can be any component of an assay of interest. The reagents can be, for example, enzymes, inorganic catalysts, dyes, binding agents, tags, antibodies, nucleic acid primers, probes or other nucleic acid constructs, cofactors, or ligands. In some embodiments, the reagents include one or more labels. As used herein, the term “label” refers to compositions detectable by spectroscopic, photochemical, biochemical, immunochemical, chemical, or other physical means. Useful labels include fluorescent dyes (fluorophores), fluorescent quenchers, luminescent agents, electron-dense reagents, enzymes (e.g., as commonly used in an ELISA), biotin, digoxigenin, ³²P and other isotopes, haptens, proteins, nucleic acids, or other substances which may be made detectable, e.g., by incorporating a label into or linking a label to an oligonucleotide, peptide, or antibody specifically reactive with a target molecule. The terms include combinations of single labeling agents, e.g., a combination of fluorophores that provides a unique detectable signature, e.g., at a particular wavelength or combination of wavelengths. In some embodiments, one or more of the reagents include one or more chromophores. In some embodiments, one or more of the reagents include one or more fluorophores. In some embodiments, one or more of the reagents include one or more quenchers.

In some embodiments, one or more of the reagents include one or more cryptate dyes. Cryptates are complexes that include a macrocycle within which a lanthanide ion such as terbium or europium is tightly embedded or chelated. This cage like structure is useful for collecting irradiated energy and transferring the collected energy to the lanthanide ion. The lanthanide ion can release the energy with a characteristic fluorescence. U.S. Pat. Nos. 6,406,297, 6,515,113, 6,864,103, 8,507,199 and 8,173,800, as well as International Patent Application No. WO 2015/157057 disclose cryptate dyes and are hereby incorporated by reference.

Cryptates can be used in various diagnostic assays. Some assays rely on time-resolved fluorescence resonance energy transfer (TR-FRET) mechanisms where two fluorophores are used. In these assays, energy is transferred between a donor fluorophore and an acceptor fluorophore if the two fluorophore are in close proximity to the each other. Excitation of the donor (cryptate) by an energy source (e.g., UV light) produces an energy transfer to the acceptor if the two fluorophores are within a given proximity. In turn, the acceptor emits light at its characteristic wavelength. In order for TR-FRET to occur, the fluorescence emission spectrum of the donor molecule must overlap with the absorption or excitation spectrum of the acceptor chromophore. Moreover, the fluorescence lifetime of the donor molecule must be of sufficient duration to allow the TR-FRET to occur. In some embodiments, the first solid composition includes a donor molecule that is a cryptate dye, and the second solid composition includes an acceptor molecule that includes a chromophore, a fluorophore, or a quencher.

### II. Kits

Also provided are kits for performing a diagnostic assay using the provided assay cuvettes. The kits include any of the cuvettes described herein, and a liquid buffer. In exemplary embodiments, the liquid buffer is selected to be suitable for dissolving the first solid composition and the first reagent. The liquid buffer is also selected to be compatible with the diagnostic assay. For example, the liquid buffer has a pH and/or an osmolarity suitable for carrying out the diagnostic assay. In some embodiments, the liquid buffer comprises one or more reagents of the diagnostic assay. The reagents can be any of the types described herein.

The diagnostic assay performed with the kit can be any small-scale laboratory procedure used to assess or measure one or more properties of a sample. For example, the assay can be used to detect the presence, amount, or activity of a target analyte. The assay can quantify one or more of the absorbance, transmission, or emission of light by the assay mixture. In some embodiments, the assay is a fluorescence resonance energy transfer (FRET) assay. FRET is a process in which a donor molecule (e.g., a cryptate dye) absorbs light, entering an excited state. Rather than emitting light, the first molecule transfers its excited state to an acceptor molecule with other properties (e.g., a dye fluorescing at a different wavelength or a quencher), and the acceptor fluoresces or quenches the excitation. Because the efficiency of the transfer is dependent on the proximity of the two molecules proximity, the signal can provide information about molecular complex formation or biomolecular structure. In some embodiments, the diagnostic assay is a FRET assay, the first solid composition includes a donor molecule, and the second solid composition includes an acceptor molecule.

As used herein, “sample” can refer to any biological specimen or sample obtained from a subject. Samples include, without limitation, whole blood, plasma, serum, red blood cells, white blood cells (e.g., peripheral blood mononuclear cells), ductal lavage fluid, nipple aspirate, lymph (e.g., disseminated tumor cells of the lymph node), bone marrow aspirate, saliva, urine, stool (i.e., feces), sputum, bronchial lavage fluid, tears, fine needle aspirate (e.g., harvested by random periareolar fine needle aspiration), any other bodily fluid, a tissue sample (e.g., tumor tissue) such as a biopsy of a tumor (e.g., needle biopsy) or a lymph node (e.g., sentinel lymph node biopsy), a tissue sample (e.g., tumor tissue) such as a surgical resection of a tumor, and cellular extracts thereof. In some embodiments, the sample is whole blood or a fractional component thereof such as plasma, serum, or a cell pellet.

As used herein, “subject” refers to animals such as mammals, including, but not limited to, primates (e.g., humans), cows, sheep, goats, horses, dogs, cats, rabbits, rats, mice and the like. In certain embodiments, the subject is a human.

As used herein, the term “analyte” refers to any molecule, compound, or complex of interest, whose presence, amount, expression level, activation state, and/or identity is determined. The determination can be through specific recognition by a binding agent. The molecule, compound, or complex of interest can be a macromolecule such as a polypeptide or protein, a polysaccharide, a toxin, a cell wall, a cell capsule, a viral capsule, a viral coat, a flagellum, a fimbria or pilus, a microorganism, a nucleic acid complexed to a protein or a polysaccharide, a lipid, a lipid complexed to a protein or a polysaccharide, a polynucleotide, a polypeptide, a carbohydrate, chemical moiety, or combinations thereof (e.g., phosphorylated or glycosylated polypeptides, etc.).

In some embodiments, the kit includes a sample. In some embodiments, the kit does not include a sample, and a sample is instead provided by a user of the kit. The buffer and the optional sample can each be in a separate apparatus. For example, the buffer and/or the sample can each be in a separate bottle, ampule, or syringe. The buffer, sample, and cuvette of the kit can be packaged together within, for example, a box, a bag, or a foil or plastic pouch. The packaging of individual components of the kit or the kit as a whole can be sealed in such a way as to indicate evidence of tampering.

### III. Methods

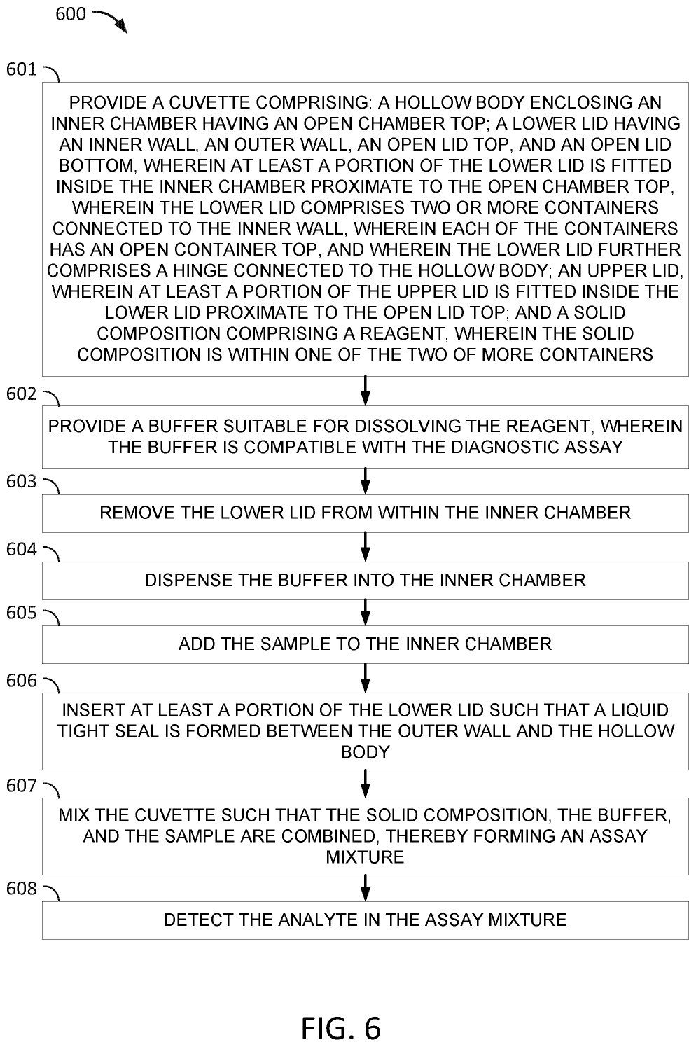

FIG. 6 presents a flowchart of a method (600) in accordance with an embodiment for detecting an analyte in a sample. In operation 601, a cuvette is provided comprising: a hollow body enclosing an inner chamber having an open chamber top; a lower lid having an inner wall, an outer wall, an open lid top, and an open lid bottom, wherein at least a portion of the lower lid is fitted inside the inner chamber proximate to the open chamber top, wherein the lower lid comprises two or more containers connected to the inner wall, wherein each of the containers has an open container top, and wherein the lower lid further comprises a hinge connected to the hollow body; a upper lid, wherein at least a portion of the upper lid is fitted inside the lower lid proximate to the open lid top; and a solid composition comprising a reagent, wherein the solid composition is within one of the two or more containers. The cuvette provided in the method can be any of the cuvettes as described above. The cuvette can be provided as a component of any of the kits as described herein.

In operation 602, a buffer suitable for dissolving the reagent is provided. The buffer provided in the method can be any of the liquid buffers as described herein. The liquid buffer can be provided as a component of any of the kits as described above.

In operation 603, the lower lid is removed from within the inner chamber. In some embodiments, a spacer optionally having a tab is positioned between the lower lid and the hollow body, and the removing of the lower lid includes lifting the spacer and the lower lid from the hollow body.

In operation 604, the buffer is dispensed into the inner chamber. In some embodiments, the buffer is a liquid solution contained within a breakable and flexible plastic ampule. The cap of the ampule can be broken off by, for example, twisting, and the body of the ampule can be squeezed to dispense the liquid buffer from the ampule into the inner chamber of the hollow body of the cuvette.

In operation 605, the sample is added to the inner chamber. The sample provided in the method can be any of the samples as described herein. In certain embodiments, the sample can also be provided as a component of any of the kits as described herein. In other embodiments, the sample can be provided by the user separately from a kit. In some embodiments, the sample is derived from an animal. In some embodiments, the sample is derived from a human. In some embodiments, the sample includes blood. In some embodiments, the sample includes urine. In some embodiments, the sample is contained within a syringe, and the adding of the sample to the inner chamber includes pressing on the plunger of the syringe to eject the sample from the syringe into the inner chamber of the hollow body of the cuvette.

In operation 606, at least a portion of the lower lid is inserted inside the inner chamber proximate to the open chamber top. In some embodiments, all of the lower lid is inserted inside the inner chamber. In some embodiments, inserting the lower lid includes pressing the combined lower lid and upper lid firmly into the inner chamber of hollow body of the cuvette until all of the lower lid and the upper lid are within a recessed rim of the hollow body. In this way, it is difficult to remove the lower lid from within the inner chamber once inserted. This in turn reduces the likelihood that a user will reopen the chamber after the components of the diagnostic assay have been added, thereby potentially interfering with or otherwise compromising the assay.

In operation 607, the cuvette is mixed such that the solid composition, the buffer, and the sample are combined, thereby forming an assay mixture. In some embodiments, the mixing includes gently inverting the cuvette one or more times. In some embodiments, the mixing includes shaking the cuvette. In some embodiments, the mixing includes vortexing the cuvette. The mixing is typically repeated until the solid reagent compositions within the lower lid have been fully dissolved by the liquid buffer. In some aspects, the mixing of the cuvette is performed by an automated device or instrument.

In operation 608, the analyte in the assay mixture is detected. The detecting of the analyte can include the detecting of an optical response of the assay mixture to a stimulation. A detectable optical response can include a change in, or occurrence of, an optical signal that is detectable either by observation or instrumentally. Typically, the detectable response is a change in light or fluorescence, such as a change in the intensity, lifetime, polarization, excitation wavelength distribution, or emission wavelength distribution of fluorescence, or a combination thereof. Some assay mixture compounds exhibit little fluorescence emission, but are useful as quenchers or chromophoric dyes. Such chromophores are useful as energy acceptors in FRET applications, or to impart a desired color to a sample or portion of a sample.

Reference to a “first” component does not necessarily require that a second component be provided. Moreover reference to a “first”, “second”, or “third” component does not limit the referenced component to a particular location unless expressly stated. The terms “first”, “second”, and “third” when used herein with reference to elements or properties are simply to more clearly distinguish the two or more elements or properties and unless stated otherwise are not intended to indicate order. As used herein, “a” or “an” means “at least one” or “one or more.”

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A cuvette (100) for separately holding solid and/or liquid reagents of a diagnostic assay, the cuvette comprising:
a hollow body (101) enclosing an inner chamber (102) having an open chamber top (103);
a lower lid (104) having an inner wall (105), an outer wall (106), an open lid top (107), and an open lid bottom (108), wherein at least a portion of the lower lid (104) is configured to fit inside the inner chamber (102) proximate to the open chamber top (103), wherein the lower lid (104) comprises one or more containers (109) connected to the inner wall (105), wherein each of the containers (109) has an open container top (110), and wherein the lower lid (104) further comprises a securing means connected to the hollow body (101); and
an upper lid (112), wherein at least a portion of the upper lid (112) is configured to fit inside the lower lid (104) proximate to the open lid top (107).

2. The cuvette (100) of claim 1, wherein an outer liquid tight seal is formed between the lower lid outer wall (106) and the hollow body (101) upon insertion of the lower lid (104) into the hollow body (101).

3. The cuvette (100) of claim 1, wherein an inner liquid tight seal is formed between the upper lid (112) and the lower lid inner wall (105) upon insertion of the upper lid (112) into the lower lid (104).

4. The cuvette (100) of claim 1, wherein the securing means comprises a hinge (111).

5. The cuvette (100) of claim 1, wherein the securing means comprises a tether.

6. The cuvette (100) of claim 1, wherein the one or more containers (109) are disposed along a strap (120) that is connected to the inner wall (105).

7. The cuvette (100) of claim 6, wherein the strap (120) is connected to the inner wall (105) at no more than two locations.

8. The cuvette (100) of claim 1, wherein the hollow body further comprises an optical window (121) having an inner window surface (122) and an outer window surface (123), and wherein the inner window surface (122) and the outer window surface (123) are substantially parallel to one another.

9. The cuvette (100) of claim 8, wherein the inner window surface (122) and the outer window surface (123) each independently have a draft angle with a magnitude less than 5 degrees.

10. The cuvette (100) of claim 8, wherein the optical window (121) is transparent to visible light.

11. The cuvette (100) of claim 8, wherein at least a portion of the hollow body (101) is transparent to ultraviolet light.

12. The cuvette (100) of claim 1 wherein the one or more containers (109) each independently comprise a thermoplastic elastomer.

13. The cuvette (100) of claim 1, wherein the lower lid (104) comprises an thermoplastic elastomer.

14. The cuvette (100) of claim 1, wherein the hollow body (101) further comprises an upper surface (115) extending outward from the open chamber top (103), wherein the lower lid (104) further comprises a flange (116) extending outward from the outer wall (106) of the lower lid (104), and wherein the cuvette (100) further comprises:
a spacer positioned between and in contact with the upper surface (115) and the flange (116) when the lower lid (104) is inserted into the inner chamber (102).

15. The cuvette (100) of claim 14, wherein the spacer comprises a tab extending outward from the hollow body (102).

16. The cuvette (100) of claim 1, wherein the hollow body comprises two or more feet (116) configured to support the cuvette in an upright standing position.

17. The cuvette (100) of claim 16, further comprising:
a horizontal air gap (117) between each of the two or more feet and the inner chamber (102).

18. The cuvette (100) of claim 1, wherein a portion of the hollow body comprises a substantially cylindrical outer surface (118), and wherein a portion of the hollow body (102) comprises a substantially planar and rectangular outer surface (119).

19. The cuvette (100) of claim 18, wherein the substantially planar and rectangular outer surface (119) comprises printed indicia.

20. The cuvette (100) of claim 19, wherein the printed indicia comprises a barcode.

21. The cuvette (100) of claim 1, wherein each of the one or more containers (109) further has an open container bottom.

22. The cuvette (100) of claim 1, further comprising:
a first solid composition (113) comprising a first reagent, wherein the first solid composition is within one of the one or more containers (109).

23. The cuvette (100) of claim 22, wherein the first solid composition (113) is a bead or a pellet.

24. The cuvette (100) of claim 23, wherein the bead or pellet comprises a lyophilized form of the first reagent.

25. The cuvette (100) of claim 23, wherein the bead or pellet comprises a solid support that is coated with the first reagent.

26. The cuvette (100) of claim 23, wherein the bead or pellet comprises a solid support that encapsulates the first reagent.

27. The cuvette (100) of claim 22, wherein the first reagent comprises a chromophore, a fluorophore, or a quencher.

28. The cuvette (100) of claim 27, wherein the first reagent comprises a cryptate dye.

29. The cuvette (100) of claim 22, wherein the lower lid (104) comprises two or more containers (109), and wherein the cuvette (100) further comprises:
a second solid composition (114) comprising a second reagent, wherein the first and second solid compositions are each independently within a separate container of the two or more containers (109).

30. The cuvette (100) of claim 29, wherein the first solid composition (113) comprises a donor molecule and the second solid composition (114) comprises an acceptor molecule.

31. The cuvette (100) of claim 30, wherein the donor molecule comprises a cryptate dye, and wherein the acceptor molecule comprises a chromophore, a fluorophore, or a quencher.

32. The cuvette (100) of claim 29, wherein the first solid composition (113) comprises a primer and the second solid composition (114) comprises a probe.

33. A kit for performing a diagnostic assay, the kit comprising:
a cuvette (100) of claim 22, wherein the first reagent is a reagent of the diagnostic assay; and
a buffer suitable for dissolving the first reagent, wherein the buffer is compatible with the diagnostic assay.

34. A method for detecting an analyte in a sample, the method comprising:
providing a cuvette (100) comprising:
a hollow body (101) enclosing an inner chamber (102) having an open chamber top (103);
a lower lid (104) having an inner wall (105), an outer wall (106), an open lid top (107), and an open lid bottom (108), wherein at least a portion of the lower lid (104) is fitted inside the inner chamber (102) proximate to the open chamber top (103), wherein the lower lid (101) comprises one or more containers (109) connected to the inner wall (105), wherein each of the containers has an open container top (110), and wherein the lower lid (104) further comprises a securing means connected to the hollow body (101);
an upper lid (112), wherein at least a portion of the upper lid (112) is fitted inside the lower lid (104) proximate to the open lid top (107); and
a solid composition (113) comprising a reagent, wherein the solid composition (113) is within one of the one or more containers (109);
providing a buffer suitable for dissolving the reagent;
removing the lower lid (104) from within the inner chamber (102);
dispensing the buffer into the inner chamber (102);
adding the sample to the inner chamber (102);
inserting at least a portion of the lower lid (104) inside the inner chamber (102) proximate to the open chamber top (103);
mixing the cuvette (100) such that the solid composition (113), the buffer, and the sample are combined, thereby forming an assay mixture; and
detecting the analyte in the assay mixture.

35. A device for holding reagents, the device comprising:
a lower lid (104) having an inner wall (105), an outer wall (106), an open lid top (107), and an open lid bottom (108), wherein the lower lid (104) comprises one or more containers (109) for holding reagents, wherein each of the containers (109) is connected to the inner wall (105), and wherein each of the containers (109) has an open container top (110); and
an upper lid (112), wherein at least a portion of the upper lid (112) is —configured to fit inside the lower lid (104) proximate to the open lid top (107).
